(19) United States
(12) Patent Application Publication
(10) Pub. No.: US 2019/0026705 A1
(43) Pub. Date: Jan. 24, 2019

(54) PAYMENT SYSTEM USING CRYPTOCURRENCY EXCHANGES

(71) Applicant: Ki Ho LEE, Seoul (KR)

(72) Inventor: Ki Ho LEE, Seoul (KR)

(21) Appl. No.: 16/015,938

(22) Filed: Jun. 22, 2018

(30) Foreign Application Priority Data
Jul. 18, 2017 (KR) 10-2017-0090873

(51) Int. Cl. G06Q 20/06; G06Q 20/38; G06Q 20/28; G06Q 20/36

(52) U.S. Cl. CPC G06Q 20/065; G06Q 20/381; G06Q 2220/00; G06Q 20/3678; G06Q 20/28

(57) ABSTRACT

Disclosed herein is a payment system using cryptocurrency exchanges. The payment system includes: a payment means of a user who holds cryptocurrency; and a cryptocurrency exchange server configured to operate in conjunction with a payment server, to, when a payment request is made by the payment means, check the payment server for a payment request amount and pay the payment request amount to a payment account of the payment means, to subtract cryptocurrency corresponding to the payment request amount from the cryptocurrency held by the user, and to prepay the payment request amount from a deposit of a deposit account before selling the subtracted cryptocurrency, pay the payment request amount from an amount obtained by selling the cryptocurrency subtracted upon the payment request, or calculate a total amount including the payment request amount and then pay the total amount in a lump on a preset date.

### BACKGROUND

### 1. Technical Field

Embodiments of the present invention relate to a payment system using cryptocurrency exchanges.

### 2. Description of the Related Art

When there was no money, bartering was performed. As time had passed, coins and bills were created. Thereafter, with the development of technology and the advent of digitalization, a new type of currency, such as cryptocurrency, has appeared. Cryptocurrency is present in a virtual environment, unlike coins and bills which are physically and actually present in the real world.

There are about 700 types of cryptocurrencies. A representative of the cryptocurrencies is “Bitcoin,” which was first developed in 2008. Cryptocurrencies which are being actively traded include “Ethereum,” “Ripple,” “Dash,” “Litecoin”, etc. Cryptocurrencies except for Bitcoin are often called Altcoin.

Cash is withdrawn from a payment account or is transmitted via account transfer in the case of credit cards and various types of simple payment, whereas products can be purchased and sold using cryptocurrency without cash.

Cryptocurrencies are traded via cryptocurrency exchanges, such as “Korbit,” “Bithumb,” “Coinone,” etc. Each of the cryptocurrency exchanges includes a system in which a user deposits an amount into his or her account and then purchases desired cryptocurrency, and enables cryptocurrency to be stored in a cryptocurrency wallet and then traded.

Furthermore, cryptocurrency may be traded using a method of exchanging cryptocurrency via a network or the Internet, QR code, etc., and cryptocurrency may be purchased and sold at cryptocurrency-dedicated automated tell machines (NIT/Is).

However, there are very few on/offline shops where products can be purchased with cryptocurrency, and thus a problem arises in that on/offline shops are not sufficient to use. Furthermore, payment is made with cryptocurrency by using a method of performing the direct exchange of cryptocurrency between a user and a shop, and thus a problem arises in that accurate payment may not be made due to the occurrence of a profit or loss attributable to a fluctuation in the market price thereof.

### PRIOR ART DOCUMENTS

### Patent Documents

(Patent document 1) Korean Patent No. 10-0750434 (issued on Aug. 10, 2007)

(Patent document 2) Korean Patent Application Publication No. 10-2004-0072537 (published on Aug. 18, 2004)

### SUMMARY

Embodiments of the present invention provide a payment system and method which enable payment at on/offline shops, where cryptocurrency cannot be used, through cryptocurrency exchanges in conjunction with various payment means, such as a debit card, a credit card, mobile payment, etc.

According to an aspect of the present invention, there is provided a payment system using cryptocurrency exchanges, the payment system including: a payment means of a user who holds cryptocurrency; and a cryptocurrency exchange server configured to operate in conjunction with a payment server, to, when a payment request is made by the payment means, check the payment server for a payment request amount and pay the payment request amount to a payment account of the payment means, to subtract cryptocurrency corresponding to the payment request amount from the cryptocurrency held by the user, and to prepay the payment request amount from a deposit of a deposit account before selling the subtracted cryptocurrency, pay the payment request amount from an amount obtained by selling the cryptocurrency subtracted upon the payment request, or calculate a total amount including the payment request amount and then pay the total amount in a lump on a preset date.

The cryptocurrency exchange server may include: a payment request information checking unit configured to, when the payment request is made by the payment means, receive identification information of the payment means, information about the payment account, and information about the payment request amount from the payment server and identify the information; a cryptocurrency conversion unit configured to convert the payment request amount into cryptocurrency according to a market price of the cryptocurrency; a cryptocurrency subtraction unit configured to subtract the cryptocurrency, obtained via the cryptocurrency conversion unit, from the cryptocurrency held by the user; a first payment request amount payment unit configured to prepay the payment request amount into the payment account from the deposit of the deposit account before selling the cryptocurrency subtracted via the cryptocurrency subtraction unit; a second payment request amount payment unit configured to pay the payment request amount into the payment account from an amount obtained by selling the cryptocurrency subtracted upon the payment request; a third payment request amount payment unit configured to calculate a total amount including the payment request amount and accumulated for a predetermined period and then pay the total amount in a lump on a preset date; and a payment request amount settlement unit configured to sell the cryptocurrency, subtracted via the cryptocurrency subtraction unit, to a third party and deposit an amount, obtained by selling the cryptocurrency, into the deposit account.

The cryptocurrency exchange server may further include an automatic fee payment unit configured to subtract a predetermined fee for the payment request amount from the cryptocurrency via the cryptocurrency subtraction unit and receive the fee.

The cryptocurrency exchange server may further include a point management unit configured to, when settlement is completed via the payment request amount settlement unit, award points corresponding to a predetermined percentage of the payment request amount, and, when points are accumulated to a predetermined value or more, convert the cumulative points into cryptocurrency according to the market price of the cryptocurrency and then provide this obtained cryptocurrency.

The payment means may include at least one of a debit card, a credit card, and a mobile payment means; and the cryptocurrency exchange server may pay the payment request amount via any one of the first payment request amount payment unit and the second payment request amount payment unit upon payment using the debit card, and may pay the total amount including the payment request amount via the third payment request amount payment unit upon payment using any one of the credit card and the mobile payment means.

Upon payment using any one of the credit card and the mobile payment means, the cryptocurrency conversion unit may convert the total amount, including the payment request amount, into cryptocurrency according to a market price of the cryptocurrency on a preset date; and the cryptocurrency subtraction unit may subtract the cryptocurrency, obtained via the cryptocurrency conversion unit, from the cryptocurrency held by the user on a preset date.

The cryptocurrency exchange server may further include a cryptocurrency sales limit setting unit configured to temporarily set a cryptocurrency sales limit in order to, upon payment using any one of the credit card and the mobile payment means, prevent the real-time total amount including the payment request amount from being converted into cryptocurrency via the cryptocurrency conversion unit and prevent the obtained cryptocurrency from being sold from the cryptocurrency held by the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram of a payment system using cryptocurrency exchanges according to an embodiment of the present invention;

FIG. 2 is a block diagram showing the configuration of a cryptocurrency exchange server according to an embodiment of the present invention;

FIG. 3 is a view illustrating a prepayment method when a payment means according to an embodiment of the present invention is used;

FIG. 4 is a view illustrating a deferred settlement and payment method when a payment means according to an embodiment of the present invention is used; and

FIG. 5 is a view illustrating a monthly settlement and payment method when the payment means according to the embodiment of the present invention is used.

### DETAILED DESCRIPTION

The terms used here will be described in brief, and the present invention will be described in detail.

Although general terms currently widely used will be selected as terms used herein by considering their functions in the present invention as much as possible, the meanings of the terms may vary depending on the intention of a person skill in the art, custom and practice, the advent of new technology, and/or the like. Furthermore, in a specific case, a term selected by the applicant as desired may be used, in which case the meaning of the corresponding term will be described in detail in a related portion of the present specification. Accordingly, the terms used herein should be defined not based on the titles of the terms but based on the meanings of the terms and the overall context of the present invention.

When any portion is described as including any component throughout the specification, this does not mean that another component is excluded, but means that the any portion may include another component, unless otherwise specified. Furthermore, each of the terms “unit” and “module” used herein represents a unit for processing at least one function or operation, which may be implemented by hardware, software, or a combination of hardware and software.

Embodiments of the present invention will be described in detail below with reference to the accompanying drawings such that those having ordinary knowledge in the art to which the present invention pertains can easily practice the present invention. However, the present invention may be implemented in various different forms, and is not limited to the embodiments described herein. Throughout the specification, in order to clearly describe the present invention, portions unrelated to the description will be omitted. The same reference symbols will be assigned to similar portions.

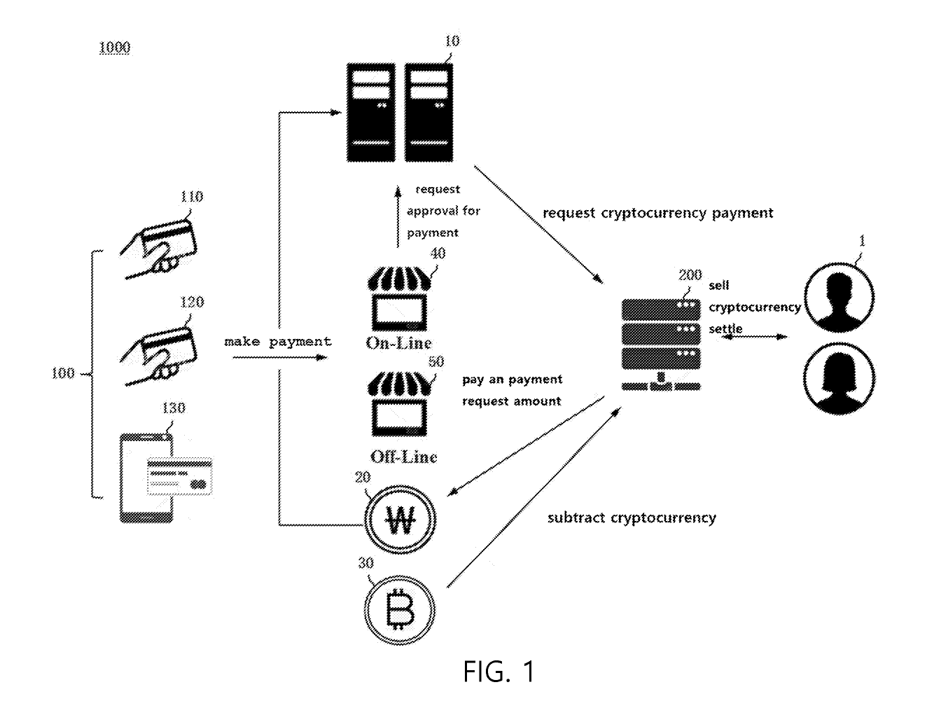

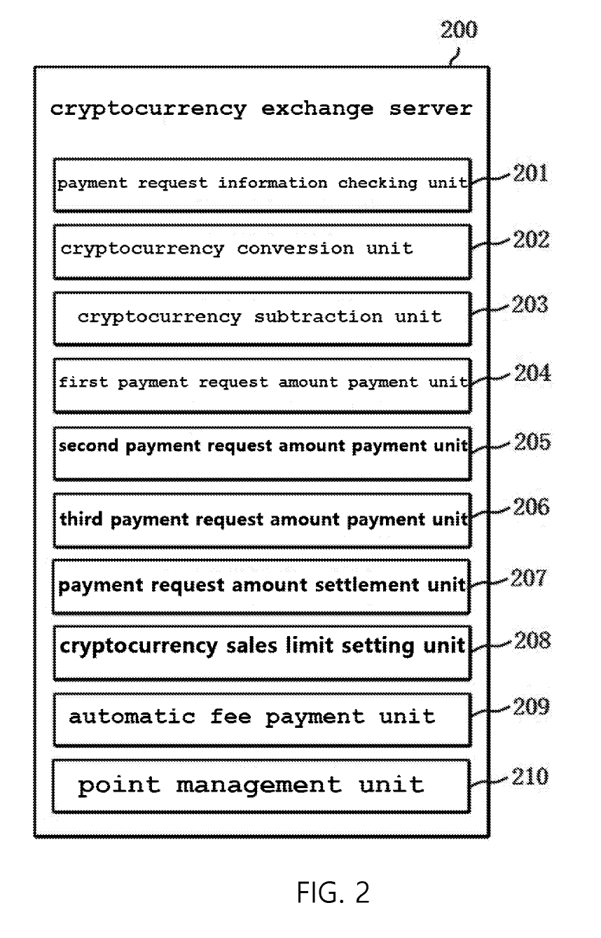

FIG. 1 is a schematic diagram of a payment system using cryptocurrency exchanges according to an embodiment of the present invention, and FIG. 2 is a block diagram showing the configuration of a cryptocurrency exchange server according to an embodiment of the present invention.

Referring to FIGS. 1 and 2, a payment system 1000 using cryptocurrency exchanges includes a payment means 100 and a cryptocurrency exchange server 200.

The payment system 1000 according to the present embodiment may operate in conjunction with the payment server 10. The payment server 10 refers to a server which is responsible for and processes a process and service related to payment when the corresponding payment is made using the payment means 100. The payment server 10 may be present in a different form which varies depending on the type of payment means 100 and the type of credit card company or communication service provider.

The payment means 100 refers to a debit card, a credit card, a mobile payment means, or the like available for a user who holds cryptocurrency. The condition for using the payment means 100 is that a corresponding user needs to have cryptocurrency charged in a cryptocurrency wallet of a cryptocurrency exchange or the like.

Furthermore, although the payment means 100 may be a common debit card, credit card, or mobile payment means, a separate cryptocurrency exchange-dedicated means may be present. In other words, a cryptocurrency exchange-dedicated card separate from a common card may be issued by the same credit card company and be used. When the payment means 100 is a mobile payment means, an interface configured to enable whether to use common payment or payment using cryptocurrency to be determined may be provided, and common payment and payment using cryptocurrency may be selectively used via the corresponding interface.

The cryptocurrency exchange server 200 is a device configured to operate a cryptocurrency exchange. The cryptocurrency exchange server 200 may be configured in the form of a separate server for each exchange. The cryptocurrency exchange server 200 operates in conjunction with the payment server 10. When a payment request is made by the payment means 100, the cryptocurrency exchange server 200 may check the payment server 10 for a payment request amount, may pay the corresponding payment request amount into the payment account 20 of the payment means 100, and may subtract cryptocurrency corresponding to the payment request amount from the cryptocurrency held by the user. However, the cryptocurrency exchange server 200 may make prepayment into the payment account by using the deposit of a deposit account managed by the cryptocurrency exchange server 200 before the sales of the subtracted cryptocurrency, may make payment by using an amount obtained by selling the cryptocurrency subtracted upon a payment request, or may calculate the cumulative total of payment request amounts and make payment in a lump on a preset date.

For this purpose, the cryptocurrency exchange server 200 may include at least one of a payment request information checking unit 201, a cryptocurrency conversion unit 202, a cryptocurrency subtraction unit 203, a first payment request amount payment unit 204, a second payment request amount payment unit 205, a third payment request amount payment unit 206, a payment request amount settlement unit 207, a cryptocurrency sales limit setting unit 208, an automatic fee payment unit 209, and a point management unit 210.

When a payment request is made by the payment means 100, the payment request information checking unit 201 may receive the identification information of the payment means 100, information about a payment account, and information about a payment request amount from the payment server 10, and may identify the information. For example, when a user uses the payment means 100 to purchase 10,000 won worth of products at an offline shop 50, the identification information of the payment means 100, the payment account number of the payment means 100, and information about 10,000 won worth of an payment request amount may be transmitted from the payment server 10 to the payment request information checking unit 201, and the payment request information checking unit 201 may identify the information.

The cryptocurrency conversion unit 202 may convert the payment request amount into cryptocurrency according to the market prices of the cryptocurrency. For example, assuming that at the time at which the payment request is made, one Bitcoin is worth 5,000 won, the payment request amount is 10,000 won and the user currently holds 10 Bitcoins, the payment request amount may be converted into 2 Bitcoins according the market price.

The cryptocurrency subtraction unit 203 may subtract the cryptocurrency, obtained by the conversion of the cryptocurrency conversion unit 202, from the cryptocurrency held by the user. For example, when the user currently holds 10 Bitcoins and the payment request amount is converted into 2 Bitcoins according to the market price, 2 Bitcoins are subtracted from 10 Bitcoins, with the result that 8 Bitcoins remain in the cryptocurrency wallet of the user. In this case, a fee may be charged for the payment request amount. The corresponding fee may be converted into cryptocurrency, and may be automatically subtracted from the cryptocurrency held by the user. This will be described in detail later in connection with the automatic fee payment unit 209.

Meanwhile, as described above, the cryptocurrency exchange server 200 may be configured in the form of a separate server for each cryptocurrency exchange. Based on a cryptocurrency exchange which is used by the user, cryptocurrency on which subtraction is performed may be determined. Furthermore, when the user uses a specific cryptocurrency exchange, the type of cryptocurrency on which subtraction is performed may be determined based on the type of cryptocurrency held by the corresponding exchange.

Meanwhile, when the user uses a plurality of cryptocurrency exchanges and a plurality of types of cryptocurrencies are held by the exchanges, the user may select one cryptocurrency exchange and the type of cryptocurrency to be used for payment. For example, when the user uses “Korbit” and “Bithumb” as cryptocurrency exchanges and the exchanges hold predetermined amounts of “Bitcoin” and “Ethereum” as cryptocurrencies, the user may directly determine whether the payment means 100 will use “Bitcoin” held via the “Korbit” exchange or “Ethereum” held via the “Bithumb” exchange as cryptocurrency for payment.

Alternatively, the cryptocurrency exchange server 200 may automatically select and change a cryptocurrency exchange and cryptocurrency to be used for payment. For example, the user may select “Korbit” and “Bitcoin” as his or her first priority, and may select “Bithumb” and “Ethereum” as his or her second priority. Thereafter, when “Bitcoin” held via the “Korbit” is all consumed or is insufficient, an automatic change may be made such that “Ethereum” held via the “Bithumb” exchange, i.e., the second priority, will be used for payment.

The first payment request amount payment unit 204 may prepay the corresponding payment request amount into the payment account 20 of the user from the deposit of a deposit account held by the cryptocurrency exchange server 200 before the subtracted cryptocurrency is sold to a third party via the cryptocurrency subtraction unit 203. More specifically, when the payment request amount is identified via the payment request information checking unit 201, the first payment request amount payment unit 204 may immediately remit the corresponding payment request amount to the payment account 20 of the user. The payment request amount to be remitted may be provided not from an amount obtained by selling the subtracted cryptocurrency to a third party but from the deposit of the deposit account for prepayment. In this case, the cryptocurrency subtracted from the user may be stored and then used for the settlement of payment later, or may be sold when the payment request amount is remitted to the payment account 20. The time at which the settlement is performed may be set by the cryptocurrency exchange server 200 itself.

In this case, the first payment request amount payment unit 204 prepays the payment request amount into the payment account 20 immediately after identifying the corresponding payment request amount before the cryptocurrency subtracted from the user is sold and used for settlement, thereby minimizing settlement processing time for the cryptocurrency and payment processing time for the user.

The second payment request amount payment unit 205 may pay the corresponding payment request amount into the payment account of the user from the sales amount of the cryptocurrency subtracted via the cryptocurrency subtraction unit 100 upon a payment request. This second payment request amount payment unit 205 may pay the payment request amount not from the deposit of the deposit account but from an amount obtained by selling the cryptocurrency subtracted from the user, unlike the first payment request amount payment unit 204.

The first payment request amount payment unit 204 and the second payment request amount payment unit 205 may operate selectively when the payment means 100 using a method in which a corresponding amount is immediately withdrawn from the payment account 20 of the user, e.g., a debit card or check card, is used upon payment. In this case, the term “selectively” means “in a way which involves the selection of a user.” In other words, the user may directly select a payment method by determining whether to use a cryptocurrency exchange via the first payment request amount payment unit 204 or a cryptocurrency exchange via the second payment request amount payment unit 205.

The third payment request amount payment unit 206 may calculate the total of payment request amounts accumulated for a predetermined period on a preset date, and may pay the total amount in a lump. In the case of a credit card or mobile micropayment, a predetermined payment date is set for each month. In the same manner, when the user uses the payment means 100, such as a credit card or mobile micropayment, it is not necessary to pay a payment request amount into the payment account 20 whenever a payment request is made. Accordingly, in accordance with the payment date of the corresponding payment means 100, the total of payment request amounts may be converted into cryptocurrency according to the market price of the cryptocurrency on the corresponding payment date, and the obtained cryptocurrency may be subtracted from the user. In this case, the corresponding total of payment request amounts may be immediately paid from the deposit account, or the corresponding total of payment request amounts may be paid into the payment account 20 in a lump from an amount obtained by selling the cryptocurrency subtracted from the user.

Meanwhile, even when the payment means 100, such as a credit card or mobile micropayment, is used, a payment method via the first or second payment request amount payment unit 203 or 204 may be applied based on user settings.

The payment request amount settlement unit 207 may perform settlement through the recovery of an amount paid into the payment account 20 by selling the cryptocurrency, subtracted via the cryptocurrency subtraction unit 203, to a third party and depositing an amount, obtained by selling the corresponding cryptocurrency, into the deposit account. When the user uses the first payment request amount payment unit 204 and a third payment request amount payment unit 206, the payment request amount settlement unit 207 may be applied, and the time at which the cryptocurrency is sold may be freely determined based on the settings of the cryptocurrency exchange server 200.

Meanwhile, when the user receives the payment request amount via the second payment request amount payment unit 205, settlement is performed by immediately selling the cryptocurrency at the time at which the corresponding cryptocurrency is subtracted from the user, and thus it is not necessary to deposit a sales amount into the deposit account.

The cryptocurrency sales limit setting unit 208 may temporarily set a cryptocurrency sales limit in order to, upon payment using any one of a credit card and a mobile payment means, prevent the real-time total amount of payment request amounts from being converted into cryptocurrency via the cryptocurrency conversion unit 202 and prevent the obtained cryptocurrency from being sold from the cryptocurrency held by the user.

For example, assuming that a credit card is used, 100 Bitcoins (a market price: 1,000 won per Bitcoin) are held, and 90,000 won has been paid with the corresponding credit card before a current payment date, 90 Bitcoins obtained by converting a total amount of 90,000 won needs to be subtracted. For this purpose, a sales limit may be temporarily set to 10 Bitcoins in order to prevent an amount larger than 90 coins from being sold from 100 Bitcoins held by the user. The reason why the sales limit of cryptocurrency is set as described above is to secure Bitcoins to be subtracted on the payment date. When payment is normally completed on the payment date, the previously set sales limit is released, and thus currently held remaining cryptocurrency may be sold.

The automatic fee payment unit 209 may receive a predetermined fee for the payment request amount by subtracting the predetermined fee from the cryptocurrency via the cryptocurrency subtraction unit 203. For example, in the case where a fee rate is 1% of an payment request amount, when an payment request amount amounts to 10,000 won, a fee may be automatically paid by subtracting cryptocurrency corresponding to 100 won from the user according to the market price of the cryptocurrency instead of receiving 100 won as the fee.

When settlement is completed via the payment request amount settlement unit 207, the point management unit 210 awards points corresponding to a predetermined percentage of the payment request amount to the user. Thereafter, once points have been accumulated to a predetermined value or more, the points may be converted into cryptocurrency and provided according to the market price of the cryptocurrency. For example, in the case where one point is awarded for a payment request amount of 1,000 won, when the cumulative total of points is 10,000 points, the points may be converted into cash, the obtained cash may be converted into cryptocurrency according to the market price of the cryptocurrency, and the cryptocurrency wallet of the user may be charged with the cryptocurrency corresponding to 10,000 points.

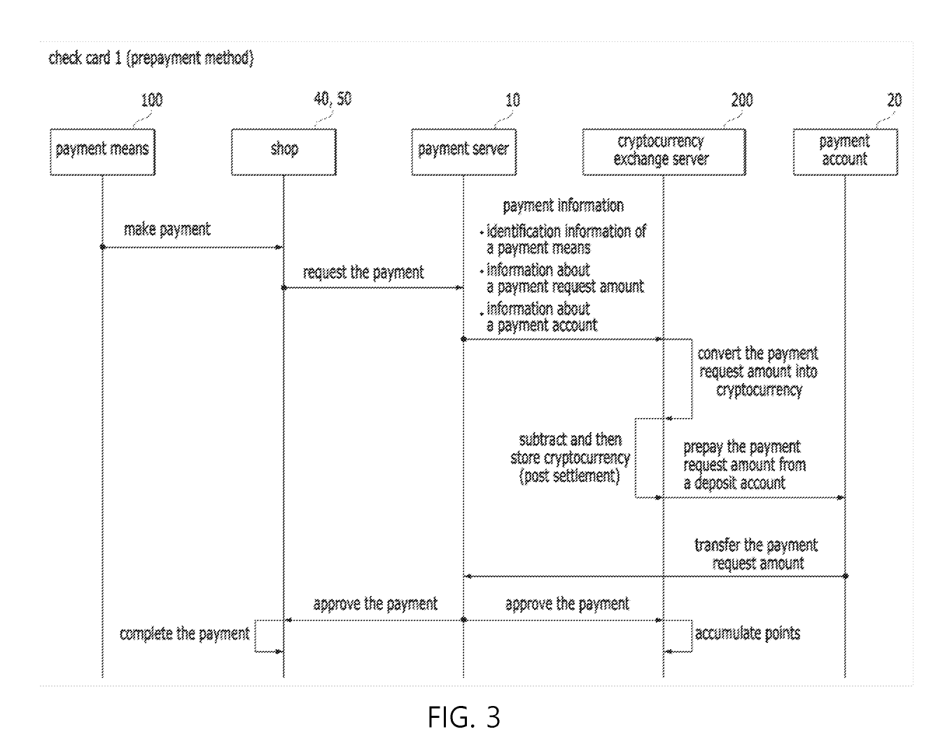

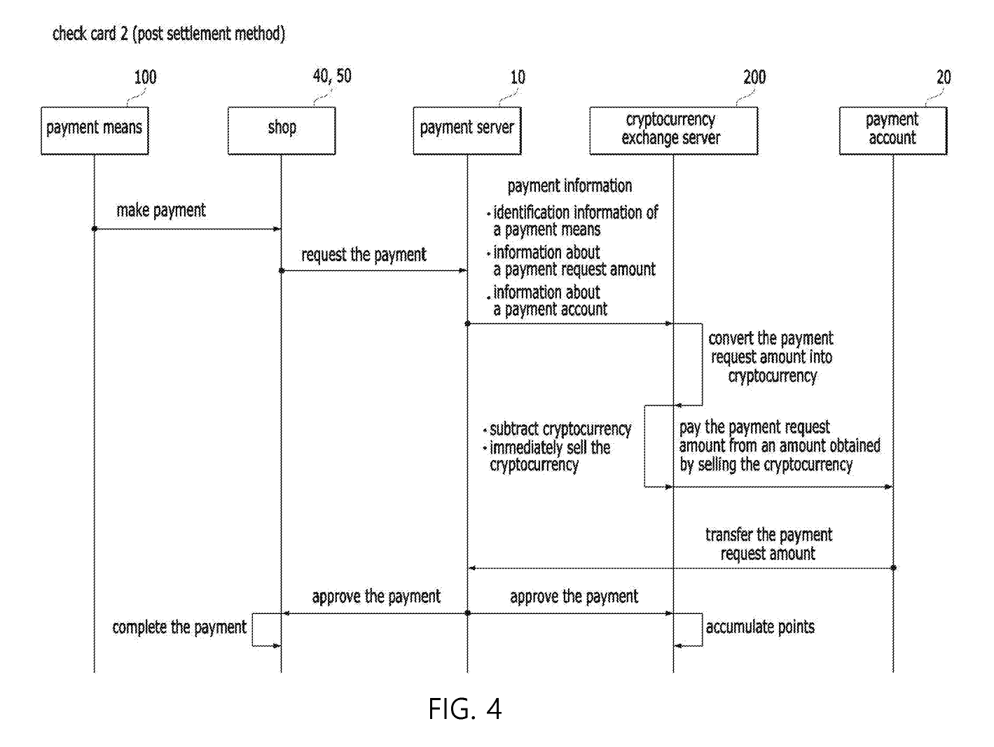

A payment method using cryptocurrency exchanges according to an embodiment of the present invention will be described below with reference to FIGS. 3 and 4.

FIG. 3 is a view illustrating a prepayment method when the payment means according to the embodiment of the present invention is used.

As shown in FIG. 3, when payment is made using the payment means 100, such as a debit card or check card, at the on/offline shop 40 or 50, the payment server 10 transfers payment information to the cryptocurrency exchange server 200. In this case, the payment information may include the identification information of the payment means, information about a payment request amount, information about a payment account, and/or the like.

Thereafter, the cryptocurrency exchange server 200 may check the payment information, received from the payment server 10, for the payment request amount, may convert the corresponding payment request amount into cryptocurrency, may subtract the obtained cryptocurrency from the cryptocurrency held by a user, and may prepay the payment request amount into the payment account 20 from a deposit account. In this case, the subtracted cryptocurrency may be immediately sold and paid. In contrast, in the case of the prepayment method shown in FIG. 3, it may be possible to pay the payment request amount into the payment account 20 from an amount previously deposited into the deposit account instead of using a sales amount as the payment request amount, i.e., selling the subtracted cryptocurrency and then depositing a sales amount into the payment account 20.

Thereafter, when the payment account 20 transfers information about the deposited payment request amount to the payment server 10, approval for the payment may be completed. In this case, the cryptocurrency exchange server 200 may accumulate points corresponding to a predetermined percentage of the payment request amount.

FIG. 4 is a view illustrating a deferred settlement and payment method when the payment means according to the embodiment of the present invention is used.

As shown in FIG. 4, when payment is made using the payment means 100, such as a debit card or check card, at the on/offline shop 40 or 50, the payment server 10 transfers payment information to the cryptocurrency exchange server 200. In this case, the payment information may include the identification information of the payment means, information about a payment request amount, information about a payment account, and/or the like.

Thereafter, the cryptocurrency exchange server 200 may check the payment information received from the payment server 10 for the payment request amount, may convert the corresponding payment request amount into cryptocurrency, may subtract the obtained cryptocurrency from cryptocurrency held by a user, and may immediately sell the subtracted cryptocurrency. In this case, an amount obtained by selling the subtracted cryptocurrency may be deposited into the payment account 20.

Thereafter, when the payment account 20 transfers information about the deposited payment request amount to the payment server 10, approval for the payment may be completed. In this case, the cryptocurrency exchange server 200 may accumulate points corresponding to a predetermined percentage of the payment request amount.

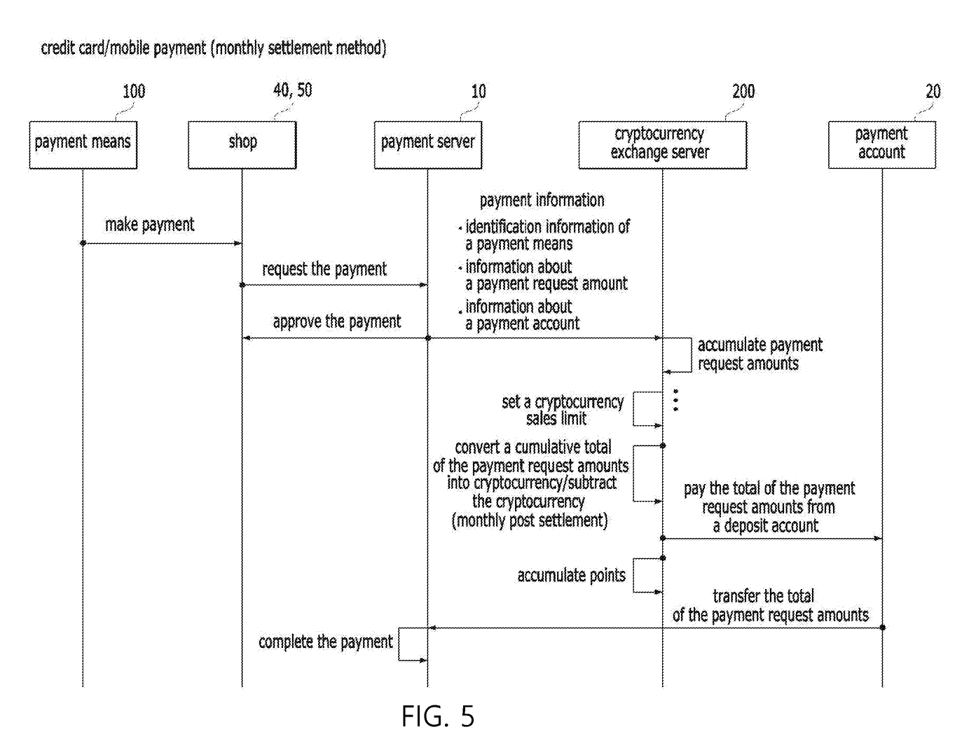

FIG. 5 is a view illustrating a monthly settlement and payment method when the payment means according to the embodiment of the present invention is used.

As shown in FIG. 5, when payment is made using the payment means 100, such as a debit card or mobile micropayment, at the on/offline shop 40 or 50, the payment server 10 transfers payment information to the cryptocurrency exchange server 200. In this case, the payment information may include the identification information of the payment means, information about a payment request amount, information about a payment account, and/or the like.

Thereafter, the cryptocurrency exchange server 200 may cumulatively shop the payment request amount selected from the payment information received from the payment server 10. During this process, a cryptocurrency sales limit for the real-time cumulative total of payment request amounts may be set in order to secure cryptocurrency for subtraction, as described above.

Thereafter, when the payment date of the corresponding payment means 100 is reached, the cryptocurrency exchange server 200 may identify the cumulative total of payment request amounts, may convert the corresponding total into cryptocurrency, and may subtract the obtained cryptocurrency from cryptocurrency held by a user.

Thereafter, the cryptocurrency exchange server 200 may deposit the total payment request amount into the payment account by using an amount obtained by selling the subtracted cryptocurrency or the deposit.

Thereafter, the cryptocurrency exchange server 200 may accumulate points corresponding to a predetermined percentage of the payment request amount. When the payment account 20 transfers information about the deposited payment request amount to the payment server 10, approval for the payment may be completed.

According to embodiments of the present invention, there may be provided the payment system and method which enable payment at on/offline shops, where cryptocurrency cannot be used, through cryptocurrency exchanges in conjunction with various payment means, such as a debit card, a credit card, mobile payment, etc.

The foregoing description has been given merely to illustrate embodiments of the payment system and method using cryptocurrency exchanges according to the present invention. The present invention is not limited to the embodiments. It will be apparent to a person having ordinary knowledge in the art to which the present invention pertains that various modifications and alterations may be made without departing from the gist of the present invention set forth in the attached claims.

What is claimed is:

1. A payment system using cryptocurrency exchanges, the payment system comprising:
a payment means of a user who holds cryptocurrency; and
a cryptocurrency exchange server configured to operate in conjunction with a payment server, to, when a payment request is made by the payment means, check the payment server for a payment request amount and pay the payment request amount to a payment account of the payment means, to subtract cryptocurrency corresponding to the payment request amount from the cryptocurrency held by the user, and to prepay the payment request amount from a deposit of a deposit account before selling the subtracted cryptocurrency, pay the payment request amount from an amount obtained by selling the cryptocurrency subtracted upon the payment request, or calculate a total amount including the payment request amount and then pay the total amount in a lump on a preset date;
wherein the cryptocurrency exchange server comprises:
a payment request information checking unit configured to, when the payment request is made by the payment means, receive identification information of the payment means, information about the payment account, and information about the payment request amount from the payment server and identify the information;
a cryptocurrency conversion unit configured to convert the payment request amount into cryptocurrency according to a market price of the cryptocurrency;
a cryptocurrency subtraction unit configured to subtract the cryptocurrency, obtained via the cryptocurrency conversion unit, from the cryptocurrency held by the user;
a first payment request amount payment unit configured to prepay the payment request amount into the payment account from the deposit of the deposit account before selling the cryptocurrency subtracted via the cryptocurrency subtraction unit;
a second payment request amount payment unit configured to pay the payment request amount into the payment account from an amount obtained by selling the cryptocurrency subtracted upon the payment request;
a third payment request amount payment unit configured to calculate a total amount including the payment request amount and accumulated for a predetermined period and then pay the total amount in a lump on a preset date; and
a payment request amount settlement unit configured to sell the cryptocurrency, subtracted via the cryptocurrency subtraction unit, to a third party and deposit an amount, obtained by selling the cryptocurrency, into the deposit account.

2. The payment system of claim 1, wherein the cryptocurrency exchange server further comprises an automatic fee payment unit configured to subtract a predetermined fee for the payment request amount from the cryptocurrency via the cryptocurrency subtraction unit and receive the fee.

3. The payment system of claim 1, wherein the cryptocurrency exchange server further comprises a point management unit configured to, when settlement is completed via the payment request amount settlement unit, award points corresponding to a predetermined percentage of the payment request amount, and when points are accumulated to a predetermined value or more, convert the cumulative points into cryptocurrency according to the market price of the cryptocurrency and then provide this obtained cryptocurrency.

4. The payment system of claim 1, wherein:
the payment means comprises at least one of a debit card, a credit card, and a mobile payment means; and
the cryptocurrency exchange server:
pays the payment request amount via any one of the first payment request amount payment unit and the second payment request amount payment unit upon payment using the debit card; and
pays the total amount including the payment request amount via the third payment request amount payment unit upon payment using any one of the credit card and the mobile payment means.

5. The payment system of claim 4, wherein:
upon payment using any one of the credit card and the mobile payment means:
the cryptocurrency conversion unit converts the total amount, including the payment request amount, into cryptocurrency according to a market price of the cryptocurrency on a preset date; and
the cryptocurrency subtraction unit subtracts the cryptocurrency, obtained via the cryptocurrency conversion unit, from the cryptocurrency held by the user on a preset date.

6. The payment system of claim 5, wherein the cryptocurrency exchange server further comprises a cryptocurrency sales limit setting unit configured to temporarily set a cryptocurrency sales limit in order to, upon payment using any one of the credit card and the mobile payment means, prevent the real-time total amount including the payment request amount from being converted into cryptocurrency via the cryptocurrency conversion unit and prevent the obtained cryptocurrency from being sold from the cryptocurrency held by the user.
